(19) United States
(12) Patent Application Publication
(10) Pub. No.: US 2004/0000178 A1
(43) Pub. Date: Jan. 1, 2004

(54) Structure of a key and locker

(76) Inventor: Hsieh Lung Tseng, Taipei (TW)

Correspondence Address: Tseng Hsieh Lung, PO Box 82-144, Taipei, TW

(21) Appl. No.: 10/301,697

(22) Filed: Nov. 22, 2002

(30) Foreign Application Priority Data
Jun. 28, 2002 (TW) 091114469

(51) Int. Cl. E05B 19/06; E05B 27/06

(52) U.S. Cl. 70/358; 70/409

(57) ABSTRACT

A structure of a key and locker is disclosed. The key structure has a key board including a first bead hole region on the dual recess regions of surface of the board or a second bead hole region on the lateral side of the key, characterized in that wider surface of the key is provided with external protruded stripes on the key board thereof, and the external protruded stripes are the third row bead region having provided with at least a bead hole, forming into a multiple codes with a plurality of axial beads on a single lateral side of the key.

### BACKGROUND OF THE INVENTION

(a) Technical Field of the Invention

The present invention relates to a key and locker structure, and in particular, to a key having one or two sided key surface provided with a plurality of holes for beads.

(b) Description of the Prior Art

Conventionally, the cross-section of a key body is either a “-” shape, a cross-sectional shape, and a circular shape. No matter what shape of the key body, the location of the pre-embedded code area of the key body is always at the top, bottom and the lateral side thereof. That is, the simple type of locker is either a single axle bead or a single axle bead with a lateral row of beads forming a dual-row bead design. The degree of complication of the locker is to control variable factors. In other words, the more the variable factors, the locker is comparatively difficult to be broken off. The control variable factors of a locker depend on the shape of the cross section of locker, the position of the row of bead region, the number of the row of bead region, the position of the row of bead, the number of row of bead, and the depth of the bead hole (normally, option 1-5 being the different in depth). Illegal unlocking of a locker or the broken of a locker is by meant of a rigid tool inserted into the locking hole and rotating the tool within the hole so as to forcefully damage the pre-embedded beads. The row of bead region is damaged when the tool forcefully rotates the circumference of the region. In view of the above, it is an object of the present invention to provide structure of a key and locker which mitigates the above drawbacks.

### SUMMARY OF THE INVENTION

Accordingly, it is an object of the present invention is to provide a structure of a key and locker, a key board including a first bead hole region on the dual recess regions of surface of the board or a second bead hole region on the lateral side of the key, characterized in that wider surface of the key is provided with external protruded stripes on the key board thereof, and the external protruded stripes are the third row bead region having provided with at least a bead hole, forming into a multiple codes with a plurality of axial beads on a single lateral side of the key.

Yet another object of the present invention is to provide a structure of a key and locker, wherein the two wider key faces of key board are formed into protruded stripes parallel to the key board per se and the pair of external protruded stripes are the third axial bead hole having at least one

A further object of the present invention is to provide a structure of a key and locker, wherein one of the wider key faces is formed into a protruded stripes parallel to the key board per se, and the external protruded stripe is formed at least a bead hole, and the bead hole is drilled to form into a rhombic line with the vertical the slanting face of the external protruded

Another object of the present invention is to provide a structure of a key and locker, wherein at least one bead hole is formed at any rhombic line of the protruded stripe facing outward or in vertical, and the external protruded face is provided with bead holes either in alternately or slanting mounted.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conventional cross-shaped axle pre-embedded key and a locking core.

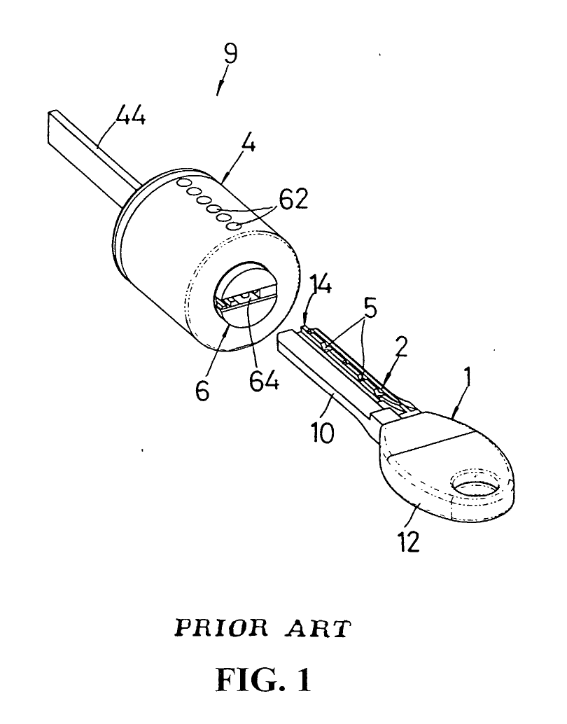

FIG. 2 is a schematic view showing a conventional slanting cross-shaped axle pre-embedded key and a locking core.

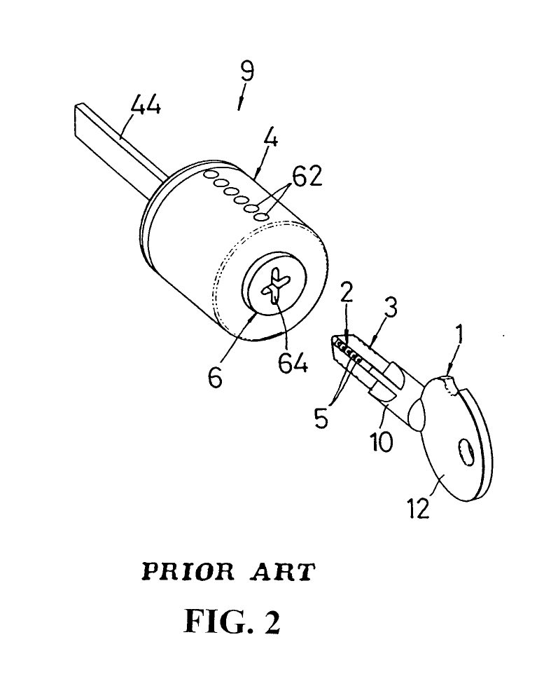

FIG. 3 is a perspective view of a key structure of the present invention.

FIG. 4 is a front view of the key structure of the present invention.

FIG. 5 is a perspective view of the key and locker in accordance with the present invention.

FIG. 6 is a schematic view showing the key being inserted into the locker core of the key in accordance with the present invention.

FIG. 7 is a schematic view showing the installation of pre-embedded beads into the locker in accordance with the present invention.

FIG. 8 shows a best mode of the preferred embodiment in accordance with the present invention.

FIG. 9 is another preferred embodiment in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

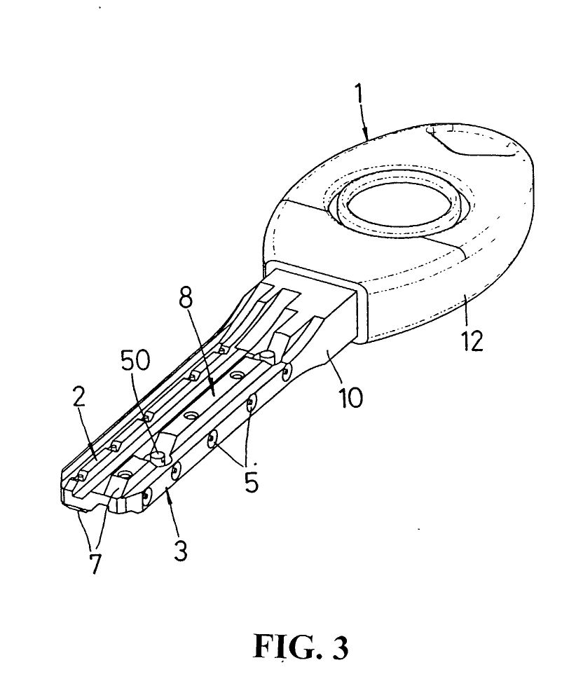

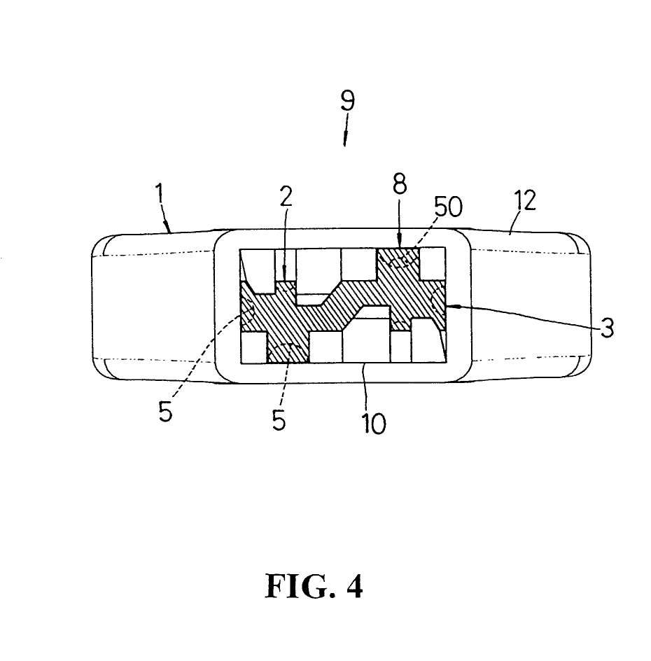

Referring to FIG. 3, there is shown a structure of a key 1 having a key board 10. A first shaft bead hole region 2 is formed on the key board 2. The second shaft bead hole region 3 is formed into a plurality of bead holes 5, and any of the wider board face of the key board 10 is formed into external protruded stripe 7 parallel to the key board 10. On the external protruded stripe 7, a third row bead hole, region 8 is formed, and at least a bead hole 5 is formed thereon. The bead hole 5 is perpendicular to or slanting to any of the rhombic line 7, forming into a single side multiple rows bead hole 5 key. Due to the fact that the position of the pre-embedded bead 62 on the external locking core 4 and the inner locking core 6 is at the slanting axial position, forcing by a hard tool is almost not possible (referring to FIG. 4).

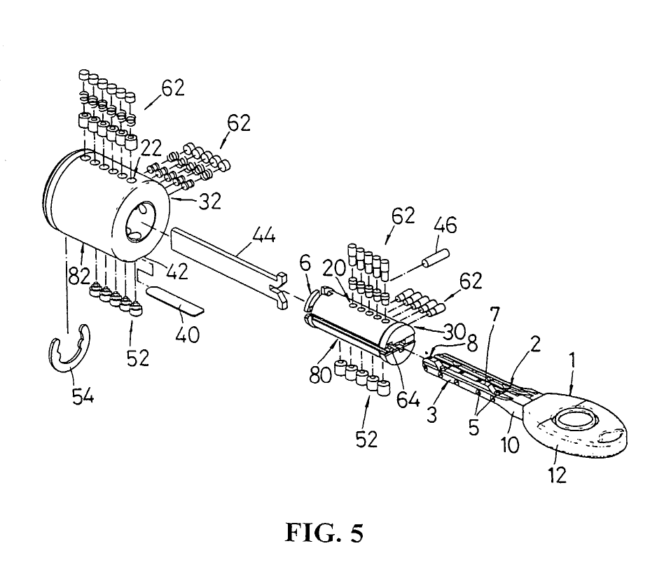

Referring to FIG. 5, the locker 9 includes the external locking core 4, and the pre-embedded bead of the inner locking core 6 is located at the rhombic line 7.

Referring again to FIG. 5, the inner locking core 6 includes a first inner bead cavity 20, a second inner bead cavity 30, and a third inner bead cavity 80 being provided with equal number of pre-embedded beads 62. The end terminal of the inner locking core 6 is mounted with a peg 46 for engaging with a rotating rod 44. The inner locking core 6 is mounted onto the external locking core 4, and the external locking core 4 corresponding to the first inner bead cavity 20, the second inner bead cavity 30, the third inner bead cavity 82 are respectively provided with a first external bead cavity 22, a second external bead cavity 32, and a third external bead cavity 62 with equal number of pre-embedded beads 62.

A C-shaped ring 54 is engaged at the end terminal of the inner locking core 6 for engagement with the inner locking core 6 and the external bead cavity 22. The pre-embedded bead 62 is a simple rivet 46, a single bead supported by a spring 56. The engaging hole 40 of the external locking core 4 is inserted with an engaging plate 40 to support a main bead 52 containing spring 56. When a key 1 is inserted into the locking hole 64 of the locker, due to the depth and position of the bead hole, the pre-embedded bead 62 and the main bead 52 are extended against the circumference.

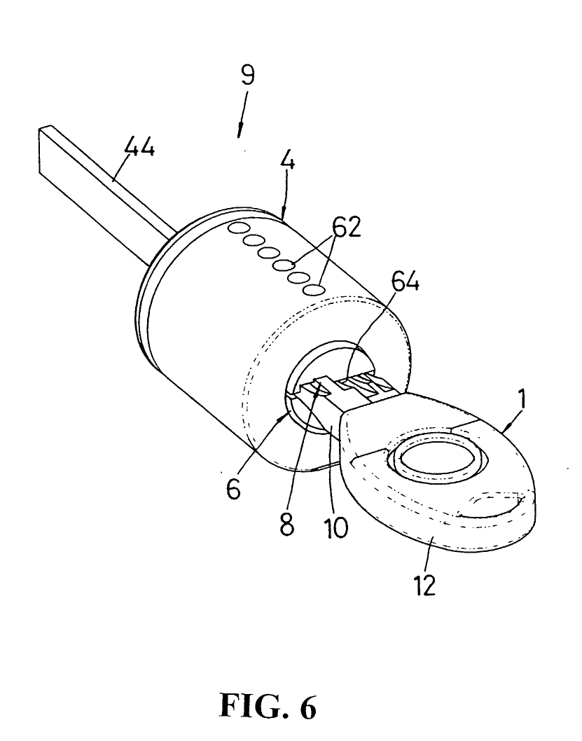

The external locker core 4 and the pre-embedded bead 62 of the inner locking core 6 or the main bead 52 will not interfere with each other. Thus, the key 1 can be rotated to drive the rotating shaft 44 to open (as shown in FIG. 6).

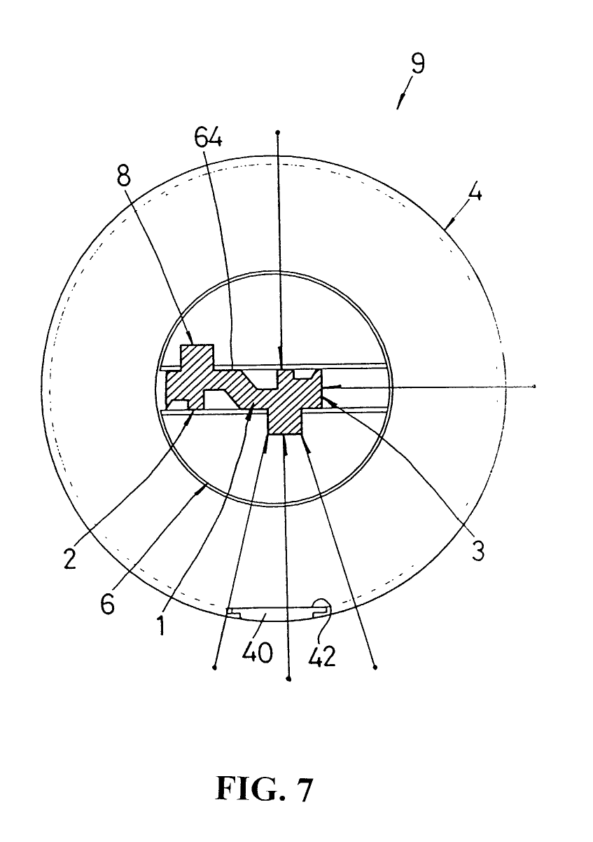

Referring to FIG. 7, there is shown a third shaft bead hole region 8 formed on the external protruded stripe 7, and the region 8 is provided with at least a pair of bead hole 5, forming into a key having dual lateral side with a plurality rows of bead holes 5. The cross section of the external protruded stripe 7 is a sharp angle, such that the insertion into the locking hole 64 is smooth.

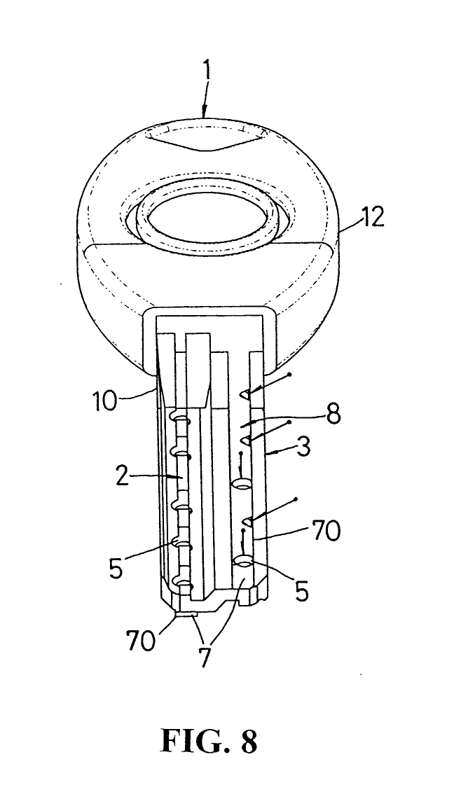

Referring to FIG. 8, there is shown one or two external protruded stripes 7 formed on the key board 10, and any of the rhombic line of the external protruded stripe 7 is provided with at least a bead hole 5. Any of the rhombic line 7 of the protruded stripe 7 beside the key board 10 is provided with bead hole 5.

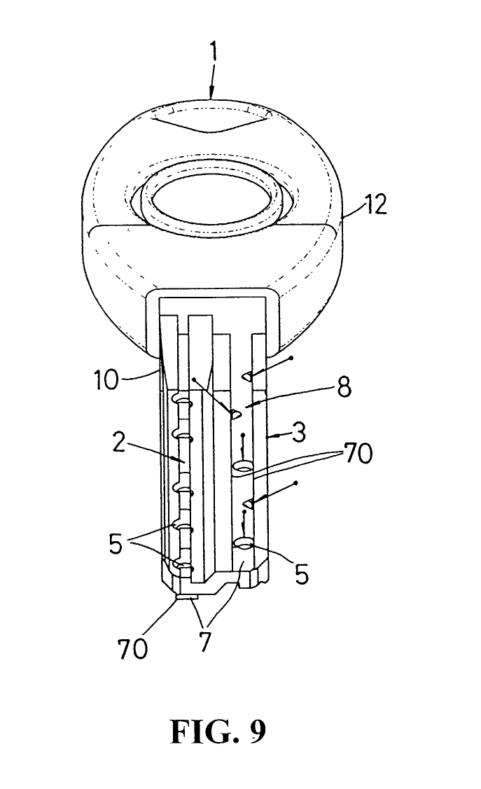

Referring to FIG. 9, any of the rhombic line 7 is provided with at least a bead hole 5 and one or two external protruded stripe 7 of the key 1 is provided with a bead hole 5. The one or two external protruded stripe 7 is provided with the bead hole 5 by alternately perpendicular to the axial a slanting to the axial direction. The pre-embedded bead 62 or the main bead 52 is mounted by pressing the rhombic line of the external protruded stripe 7. The pre-embedded bead 62 is corresponding to the one or two external protruded stripe 7 face of the key 1. The bead 62 is pivotally mounted thereto.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of a key with radially slanted embedded beads having a key board including a first bead hole region on the dual recess regions of surface of the board or a second bead hole region on the lateral side of the key, characterized in that wider surface of the key is provided with external protruded stripes on the key board thereof, and the external protruded stripes are the third row bead region having provided with at least a bead hole, forming into a multiple codes with a plurality of axial beads on a single lateral side of the key.

2. The structure of a key of claim 1, wherein the two wider key faces of key board are formed into protruded stripes parallel to the key board per se and the pair of external protruded stripes are the third axial bead hole having at least one pair of bead holes.

3. The structure of a key of claim 1, wherein one of the wider key faces is formed into a protruded stripes parallel to the key board per se, and the external protruded stripe is formed at least a bead hole, and the bead hole is drilled to form into a rhombic line with the vertical the slanting face of the external protruded

4. The structure of a key of claim 3, wherein at least one bead hole is formed at any rhombic line of the protruded stripe facing outward or in vertical, and the external protruded face is provided with bead holes either in alternately or slanting mounted.

5. The structure of a key of claim 4, wherein the cross section of the external stripe has an externally protruded sharp angle so that when the locking hole insertion is smooth.

6. A slanting axially embedded bead locker having an inner core corresponding to any wider board surface of the key board formed into external protruded stripe parallel to the key board per se and the bead hole on the external protruded stripe is provided with equal number of inner bead cavity having equal number of pre-embedded beads, the external locker core corresponding to the inner bead cavity of the inner locker core is provided with equal number of external bead cavity having provided with equal number of pre-embedded beads.

7. The structure of a key of claim 7, wherein the inner locking core corresponding to the external protruded stripes is formed into parallel by board corresponding to the two wider plate surface, and the external protruded stripes are provided with at least one inner bead cavity which is provided with an external cavity and is pivotally mounted with a plurality of pre-embedded beads.

8. The structure of a key of claim 6, wherein a rhombic line formed on any of the external protruded lines is provided with at least a bead hole and the position of the bead hole is an inner bead cavity pivotally mounted with equal number of pre-embedded bead, and the external locking core corresponding to the inner bead cavity is provided with external bead cavity pivotally mounted with equal number of pre-embedded beads.

9. The structure of a key of claim 8, wherein any of the rhombic line is provided with at least one bead hole, and the position of the bead hole is formed with a bead cavity pivotally mounted with equal number of pre-embedded beads, and the external locking core corresponding to the inner bead cavity is provided with external bead cavity pivotally mounted with equal number of pre-embedded beads.
